(19) United States
(12) Patent Application Publication
(10) Pub. No.: US 2014/0129986 A1
(43) Pub. Date: May 8, 2014

(54) METHOD FOR PROVIDING OPERANDS FOR A MATHEMATICAL OPERATION IN A CALCULATOR DEVICE

(71) Applicant: CAMILOC OY LTD, Espoo (FI)

(72) Inventor: Ismo HAUTALA, Espoo (FI)

(73) Assignee: CAMILOC OY LTD, Espoo (FI)

(21) Appl. No.: 13/667,646

(22) Filed: Nov. 2, 2012

(51) Int. Cl. G06F 3/048

(52) U.S. Cl. 715/830

(57) ABSTRACT

A method, apparatus and computer program determine first and second user input for scrolling a first band and a second band on a display. The first band and the second band comprise lines of numbers in numerical order. The first band and second band have respective positions corresponding to currently selected numbers on the bands. First and second operands are determined from the first user input and the second user input, the first operand being the currently selected number on the first band and the second operand being the currently selected number on the second band. On the display are displayed results of at least two mathematical operations involving the first operand and the second operand, in direct response to the determining of at least one of the first operand and the second operand.

### BACKGROUND OF THE INVENTION

1. Field of the Invention

The invention relates to calculators, calculator applications and a method for providing operands for a mathematical operation in a calculator device.

2. Description of the Related Art

Present calculator applications simulate a basic or scientific calculator with a three-by-three keypad. The keypad also comprises keys for different operators such as plus, minus, multiplication and division and an equals key. In present de-facto standard calculators, a user first enters a first operand, an operator and a second operand, and presses the equals key. After the press of the equals key, the result is presented to the user on the display. However, this mode of operation is not particularly suited for children who want to learn to perform basic calculations in their mind. The same also applies for adults when they want to understand how operands to a more complex calculation affect the final result. Particularly, present de-facto standard calculators make it difficult to understand deeply the effect of various operand values to the result of the calculation. It is difficult to experiment with different operand values in order to learn associations between operand values and results. It is not possible to vary only a single operand while maintaining a second operand constant. Further, it is not possible to view simultaneously the results of different operations for same operands. When a physical pocket calculator is simulated using a graphical user interface application, the experimenting becomes more difficult for a child, because it requires the selection of small keypad areas on a screen with a pointer device.

For the learning of basic calculations certain mechanical and electrical computing devices have been introduced in prior art.

Publication U.S. Pat. No. 3,645,440 teaches a mechanical calculating instrument for the teaching of basic calculations for children. The mechanical calculating instrument does not show directly the results of the calculations and requires the operation of a dialing disk several times to obtain the correct result.

Publication U.S. Pat. No. 4,016,411 teaches an electrical multiline calculator. The multiline calculator allows entering different operands using different key rows. The key rows consist of the numbers 0 to 9. The multiline calculator displays the operands on a first row and on a second row on a Light Emitting Diode (LED) display. The result is displayed on a third row of the display below a permanent summation line.

It would be beneficial to be able to provide a teaching aid that allows a child to experiment with the operands of most common mathematical operations so that the result is immediately visible. It is also beneficial if the results of several operations are visible simultaneously. It is also beneficial if the child is shown only the correct results of the operations.

### SUMMARY OF THE INVENTION

According to an aspect of the invention, the invention is a method, comprising: determining a first user input for scrolling a first band on a display, the first band comprising a first line of numbers in a numerical order, the display having a first position corresponding to a currently selected number on the first band; determining a first operand from the first user input, the first operand being the currently selected number on the first band; determining a second user input for scrolling a second band on a display, the second band comprising a second line of numbers in a numerical order, the display having a second position corresponding to a currently selected number on the second band; determining a second operand from the second user input, the second operand being the currently selected number on the second band; and displaying on the display results of at least two mathematical operations involving the first operand and the second operand, in a direct response to determining at least one of the first operand and the second operand.

According to a further aspect of the invention, the invention is an apparatus comprising: a memory; a display and at least one processor configured to determine a first user input for scrolling a first band on a display, the first band comprising a first line of numbers in a numerical order, the display having a first position corresponding to a currently selected number on the first band, to determine a first operand from the first user input, the first operand being the currently selected number on the first band, to determine a second user input for scrolling a second band on a display, the second band comprising a second line of numbers in a numerical order, the display having a second position corresponding to a currently selected number on the second band, to determine a second operand from the second user input, the second operand being the currently selected number on the second band, and to display on the display results of at least two mathematical operations involving the first operand and the second operand, in a direct response to determining at least one of the first operand and the second operand.

According to a further aspect of the invention, the invention is a computer program comprising code adapted to cause the following when executed on a data-processing system: determining a first user input for scrolling a first band on a display, the first band comprising a first line of numbers in a numerical order, the display having a first position corresponding to a currently selected number on the first band; determining a first operand from the first user input, the first operand being the currently selected number on the first band; determining a second user input for scrolling a second band on a display, the second band comprising a second line of numbers in a numerical order, the display having a second position corresponding to a currently selected number on the second band; determining a second operand from the second user input, the second operand being the currently selected number on the second band; and displaying on the display results of at least two mathematical operations involving the first operand and the second operand, in a direct response to determining at least one of the first operand and the second operand.

According to a further aspect of the invention, the invention is a computer program product comprising the computer program.

According to a further aspect of the invention, the invention is an apparatus comprising: a substantially circular housing; a first rotatable wheel around the housing; a second rotatable wheel around the housing; a wheel position sensor circuit for sensing the position of the first wheel and the second wheel; a display; and a processor configured to determine a current position of the first rotatable wheel via the wheel position sensor circuit, to determine a first operand based on the current position of the first wheel, to determine a current position of the second rotatable wheel via the wheel position sensor circuit, to determine a second operand based on the current position of the second wheel, to perform a first mathematical operation on the first operand and the second operand in response to the determination of at least one of the first operand and the second operand, to perform a second mathematical operation on the first operand and the second operand in response to the determination of at least one of the first operand and the second operand, to display the result of the first mathematical operation on a first display portion on the display, and to display the result of the second mathematical operation on a second display portion on the display.

In one embodiment of the invention, the position on the display corresponding to the currently selected number on a band way vary depending on the location of the band on the display or on a portion of the display, the portion of the display being, for example, a window displaying a calculator application comprising at least one band such as the first band and the second band. The band may be rolled or scrolled under the position on the display. The position may be indicated with a mark, for example, a chevron. The mark does not change position when the band is scrolled.

In one embodiment of the invention, the scrolling of a band may be presented for a user on the display so that the band, on which numbers are displayed in a numerical order, is reeled backwards or forwards. However, any reels may not be displayed. Scrolling of a band may be perceived as reeling of the band. The band may be reeled in respect to a mark on the display which is not reeled along with the band. The mark may be seen as if it were a cassette head of a cassette recorder.

In one embodiment of the invention, by scrolling of the bands is meant moving the bands in a direction opposite to the scrolling direction. Only part of a band is visible on the screen, therefore, the moving of a band appears as scrolling of the band for the user. In one embodiment of the invention, the scrolling may be seen as the rolling of the bands.

In one embodiment of the invention, by scrolling of a band is meant rotating an animated wheel on the display. The band is on the surface of the wheel facing the user.

In one embodiment of the invention, the step of determining the first user input further comprises determining user input which corresponds to a touch gesture for scrolling on a touch sensor array associated with the display. The touch sensor array may be a multi-touch sensor array. The step of determining the second user input may further comprise determining user input which corresponds to a touch gesture for scrolling on a touch sensor array associated with the display. A touch gesture may comprise at least one touch of the display determined by the touch sensor array. A touch gesture may comprise at least one movement of a touch area determined by the touch sensor array.

In one embodiment of the invention, the step of determining the first user input further comprises determining user input which corresponds to a selection of the first band using a navigation keypad and a pressing of a direction key on the navigation keypad. The navigation keypad may comprise an up key, a down key, a left key, a right key and a selection key for selecting an object on the display pointed to with a cursor or a pointer that is moved with the directional keys.

In one embodiment of the invention, the method further comprises determining a third user input for scrolling the first band or the second band in a direction perpendicular to the line of numbers on the first band or the second band; and displaying an updated line of numbers in increasing order on the first band or the second band with increased precision of at least one further decimal place.

In one embodiment of the invention, the method further comprises determining a fourth user input for scrolling a result area on the display for displaying the results; and changing at least one of the least two mathematical operations to a further mathematical operation in response to the fourth user input.

In one embodiment of the invention, the method further comprises displaying a third band on the display in response to the fourth user input, the third band having a default position corresponding to a currently selected default number on the third band.

In one embodiment of the invention, the first band and the second band are horizontal bands. The first band and the second band may also be vertical bands.

In one embodiment of the invention, numbers and results are displayed with number symbols that show a number of objects, the number of objects corresponding to the number being displayed. The objects may be, for example, apples, oranges, cats or ducks.

In one embodiment of the invention, the first mathematical operation or the second mathematical operation comprises one of addition, subtraction, multiplication and division. The mathematical operation may also comprise exponentiation where first operand may be the base and the second operand may be exponent. The mathematical operation may also comprise logarithm where first operand may be the base and the second operand may be the number from which the logarithm is computed.

In one embodiment of the invention, apparatus comprises at least one of a pocket computer, a bendable display computer, a tablet computer, a laptop computer, a mobile terminal, and a mobile handset.

In one embodiment of the invention, the apparatus comprises a semiconductor circuit, a chip or a chipset.

In one embodiment of the invention, the computer program is stored on a computer readable medium. The computer readable medium may be, but is not limited to, a removable memory card, a removable memory module, a magnetic disk, an optical disk, a holographic memory or a magnetic tape. A removable memory module may be, for example, a USB memory stick, a PCMCIA card or a smart memory card.

The embodiments of the invention described hereinbefore may be used in any combination with each other. Several of the embodiments may be combined together to form a further embodiment of the invention. A method, an apparatus, a computer program or a computer program product to which the invention is related may comprise at least one of the embodiments of the invention described hereinbefore.

It is to be understood that any of the above embodiments or modifications can be applied singly or in combination to the respective aspects to which they refer, unless they are explicitly stated as excluding alternatives.

The benefits of the invention are related to the possibility for a user to easily and quickly see results of a mathematical operation or a formula. The user, for example, a child may easily experiment by moving the bands and see the results change, thereby understanding more effectively the semantics of each mathematical operation. The user may also effectively perceive the relationships of the mathematical operations to one another.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a user interface of a calculator application in one embodiment of the invention;

FIG. 2 illustrates a user interface of a calculator application with decimal points in one embodiment of the invention;

FIG. 3 is a flow chart illustrating a method for providing operands to a mathematical operation in a calculator device in one embodiment of the invention;

FIG. 4 is a block diagram illustrating a calculator in one embodiment of the invention; and

FIG. 5 illustrates an electronic device in one embodiment of the invention.

### DETAILED DESCRIPTION OF THE EMBODIMENTS

Reference will now be made in detail to the embodiments of the present invention, examples of which are illustrated in the accompanying drawings.

FIG. 1 illustrates a user interface of a calculator application in one embodiment of the invention. The user interface may also be used in a dedicated calculator device. The user interface consists of a main window 100. The main window may be on a touch sensitive display. The display may be a multi-touch display, which may be configured to sense multiple areas of touch on the display simultaneously.

On main window 100 there is a first movable band 110. First movable band 110 comprises integer numbers 0 to 100 in increasing order in one embodiment of the invention. The number of integer numbers on band 110 may vary from embodiment to embodiment. In FIG. 1, of the integer numbers 0 to 100 are shown on main window 100 only integer numbers 0 to 14, that is, the numbers that fit on the portion of band 110 on main window 100 so that sufficient font size and readability are maintained. By moving band 110 to the left, for example, with a touch, remaining numbers 14 to 100 may be revealed. If band 110 has already been moved to the left previously, it may be moved to the right to reveal again smaller numbers. It should be noted that moving to the left of a band may be referred to as scrolling to the right from the point of view of the numbers on the band. Similarly, moving to the right of a band may be referred to as scrolling to the left from the point of view of the numbers on the band. In this context the expression of moving of a band is used interchangeable with the expression of scrolling of a band. The band may not be moved on the display to appear in different places. When a band is moved, hidden parts of the band may be revealed even though the place and the size of the band on the display remain the same.

In one embodiment of the invention, by the expression in direct response to the determining of an operand is meant that the user is not required to select a button, a display area or press a key in order to have the result of a mathematical operation computed.

In one embodiment of the invention, the mathematical operation may comprise a mathematical formula computed using the operands as variables in the formula.

In one embodiment of the invention, there may be more than two bands displayed on the display.

In one embodiment of the invention, the moving of band 110 to the left is achieved by moving a touch area to the left on a touch screen. The moving of band 110 to the right is achieved by moving a touch area to the right on a touch screen.

In one embodiment of the invention, the moving of band 110 to the left is achieved by selecting band 110 with pointer navigation keys, and after the selection, moving band 110 to the left by pressing a right pointer key. The selection may be performed by pressing a middle key between direction keys in a pointer navigation keypad. The moving of band 110 to the right is achieved by selecting band 110 with pointer navigation keys, and after the selection, moving band 110 to the right by pressing a left pointer key.

The possibility of moving band 110 is illustrated with double-ended arrow 114. A currently selected number among the numbers on band 110 is indicated with chevron 112 or other mark such as an arrow or a triangle. The currently selected number may also be framed with a box or it may be encircled. The currently selected number “8” is shown in FIG. 1. The currently selected number on band 110 becomes a first operand in a mathematical operation.

On main window 100 there is also a second movable band 120. Second movable band 120 is functionally equivalent to first movable band 110. Currently selected number is indicated with chevron 122 or other mark. The possibility of moving band 120 is illustrated with double-ended arrow 124. The currently selected number on band 120 becomes a second operand in a mathematical operation.

On main window 100 there is also illustrated a result area 130 which is used to display the results of at least two mathematical operations performed on the first operand and the second operand. The result area 130 is always updated directly in response to the selection of a new number on either band 110 or band 120. In result area 130 the currently selected number on band 110 is displayed as first operand 132. Similarly, the currently selected number on band 120 is displayed as second operand 134. The mathematical operation may be addition. The result 136 is displayed following the “=” equals character. On the first operand from band 110 and the second operand from band 120 are performed in FIG. 1 four different mathematical operations, that is, addition, subtraction, multiplication and division. Instead of these operations other mathematical operations may be substituted such as exponent or logarithm. The results are displayed following the “=” equals character on the display. The results are always updated after the selection of a new current number from either band 110 or band 120. There is no need, for example, to select or press a button for equals “=” in order to see the new results.

In one embodiment of the invention, on band 110 and band 120 there are also negative integers, for example, so that bands 110 and 120 comprise integers −100 to 100.

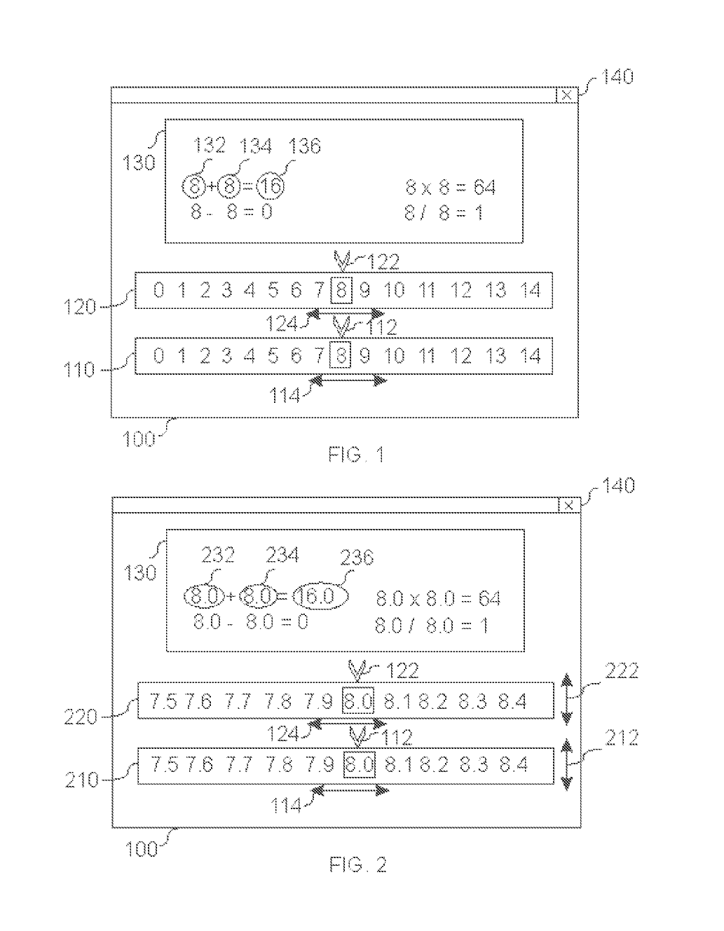

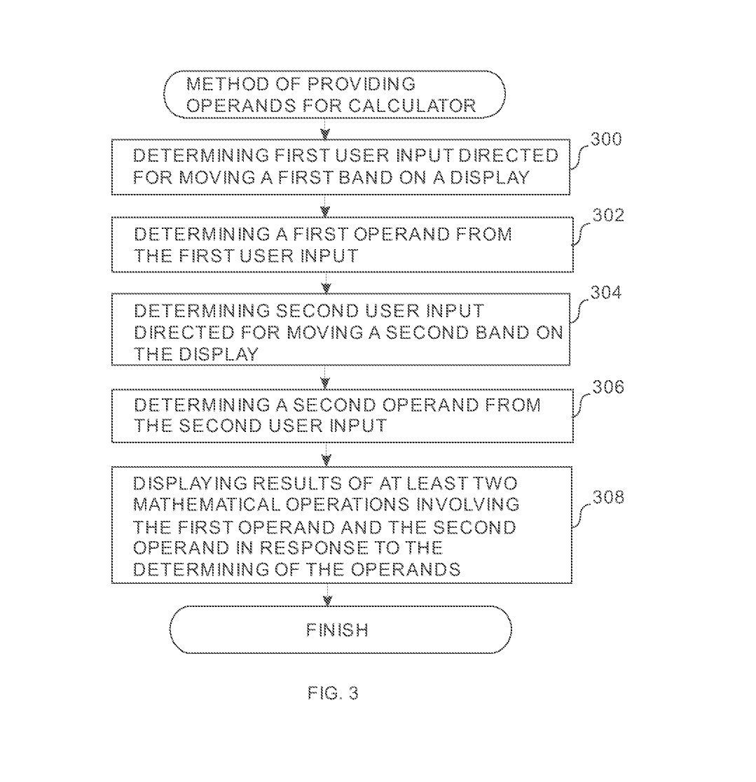

FIG. 2 illustrates a user interface of a calculator application with decimal points in one embodiment of the invention. In FIG. 2 the movable bands 110 and 120 have been replaced with enhanced movable bands 210 and 220. Movable bands 210 and 220 may be touch movable bands. Movable bands 210 and 220 may also be scrolled with navigation keys after they have been selected with the navigation keys as explained in association with FIG. 1. Band 210 comprises numbers 0 to 100 in increasing order in steps of 0.1. Similarly, band 210 comprises numbers 0 to 100 in increasing order in steps of 0.1. The numbers on band 210 and band 220 may vary from embodiment to embodiment. In FIG. 2, of the numbers 0 to 100 in steps of 0.1 are shown on main window 100 only numbers 7.5 to 8.4 in steps of 0.1, that is, the numbers that fit on the portion of bands 210 and 220 on main window 100 so that sufficient font size and readability are maintained. As illustrated with arrows 212 and 222 movable bands 210 and 220 may also be moved in vertical direction. The moving of either band 210 or band 220 upwards one step increases the precision of numbers on the band moved by one decimal place. When a band is moved upwards, previously hidden parts in a lower portion of the band are revealed. The moving may be seen as the digging of further precision for the numbers so that further precision may be revealed by looking deeper down on the bands 210 or 220. While the number “8” is currently selected on band 210, the user may move the band upwards so that the precision of numbers on band 210 is increased by one decimal place so that number “8.0” becomes currently selected. The same may be performed for band 220 thereby resulting to the situation illustrated in FIG. 2.

In one embodiment of the invention, the moving of a band upwards may be performed by moving a touch area intersecting the band upwards. Similarly, the scrolling of a band downwards may be performed by moving a touch area intersecting the band downwards. The scrolling of a band downwards or upwards by touch may be limited to sides of the band in order to avoid misinterpretations whether the user desires to scroll the band horizontally or vertically.

In one embodiment of the invention, the moving of a band upwards may be performed by selecting the band with navigation keys and moving the selected band upwards by pressing a down navigation key. Similarly, the moving of a band downwards may be performed by selecting the band with navigation keys and moving the selected band downwards by pressing an up navigation key.

In one embodiment of the invention, the bands 210 and 220 may also be seen to have a cross section in the form of a line, a triangle, a square or a polygon depending on the number of precision levels, that is, decimal places that may be displayed. Therefore, the bands 210 and 220 may be seen to have a hidden shape of a bar such as a triangle cross section ruler. The cross section is performed vertically from the point of view of the user. Each surface of the bands 210 and 220 comprises numbers of a specific precision in increasing order. The downward scrolling changes the surface of the band scrolled. Bands 210 and 220 may also be seen as doughnuts that may be rotated around with touch or navigation keys.

The moving of either band 210 or band 220 downwards one step decreases the precision of numbers on the band moved by one decimal place. For example, initially on band 210 are shown only integer numbers from 0 to 14.

It should be noted that moving of a band upwards may be referred to as scrolling down. Similarly, the moving of a band downwards may be referred to as scrolling up. The band may not be moved on the display to appear in different places. When a band is moved, hidden parts of the band may be revealed even though the place and the size of the band on the display remain the same. If the precision is increased by moving band 210 or 220 upwards, band 210 or 220 may be thought of having the same number on the same column with different precisions on different rows so that the precision increases by one decimal place row by row in a column.

The result area 130 in FIG. 2 is always updated directly in response to the selection of a new number on either band 210 or band 220. In result area 130 the currently selected number on band 210 is displayed as first operand 232. Similarly, the currently selected number on band 220 is displayed as second operand 234. The mathematical operation may be addition. The result 236 is displayed following the “=” equals character. On the first operand from band 210 and the second operand from band 220 are performed in FIG. 2 four different mathematical operations, that is, addition, subtraction, multiplication and division. In place of these mathematical operations may be any other mathematical operations.

In one embodiment of the invention, the user may switch between different calculator types. The user may switch to use a calculator tailored to specific applications. The switching of calculator type from a first calculator type to a second calculator type may be performed on a touch screen by moving the result area 130 aside so that at least a predefined part of result area 130 gets outside the display.

The number of bands used to select the operands for a mathematical operation may vary on main window 100. There may be three bands in a commercial calculator used for computing annuities for a mortgage. A first band is used to select the loan amount, a second band may be used to select the number of years and a third band may be used to select the interest rate. The result is displayed on result area 130 after any of the bands is moved from initial position.

In one embodiment of the invention, the user may be provided with a user interface form for defining new calculator types. The calculator types may correspond to different formulae and different application areas such as computation of mortgages or medicine dosages. In the user interface form the user may select the number of operands and hence the number of bands displayed on display. The user may enter the formula for computing a result based on the operands. In the formula the operands may be referred to using variables such as O1 for first operand, O2 for second operand and so on. The user may specify the operand ranges for each operand and the desired step sizes for each operand. The step sizes correspond to the number of decimal places that may be revealed by moving the respective band in upward direction.

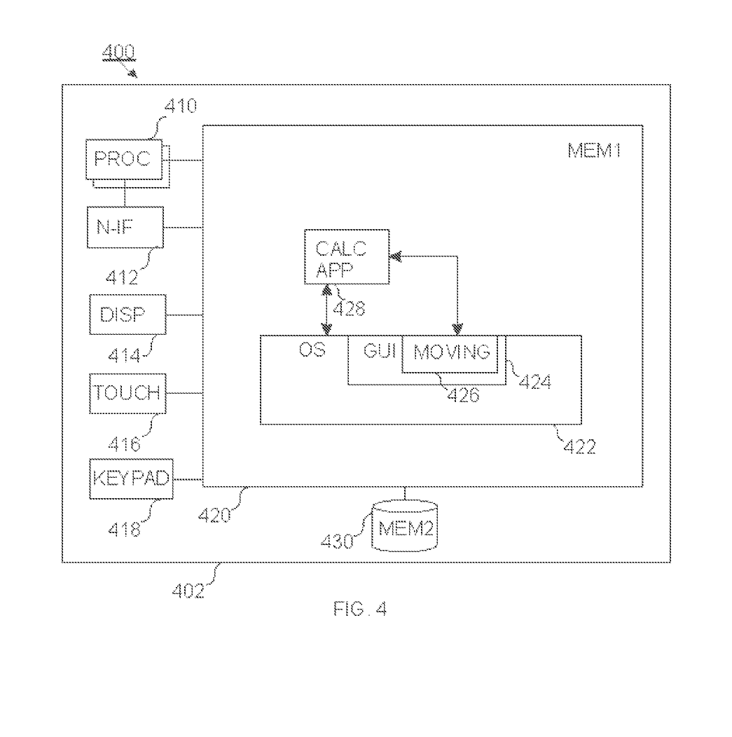

FIG. 3 is a flow chart illustrating a method for providing operands to a mathematical operation in a calculator device in one embodiment of the invention.

At step 300 is determined first user input for moving a first band on a display.

At step 302 a first operand is determined from the first user input.

At step 304 is determined second user input for moving a second band on a display.

At step 306 a second operand is determined from the second user input.

At step 308 is displayed the results of at least two mathematical operations involving the first operand and the second operand in response to determining at least one of the first operand and the second operand.

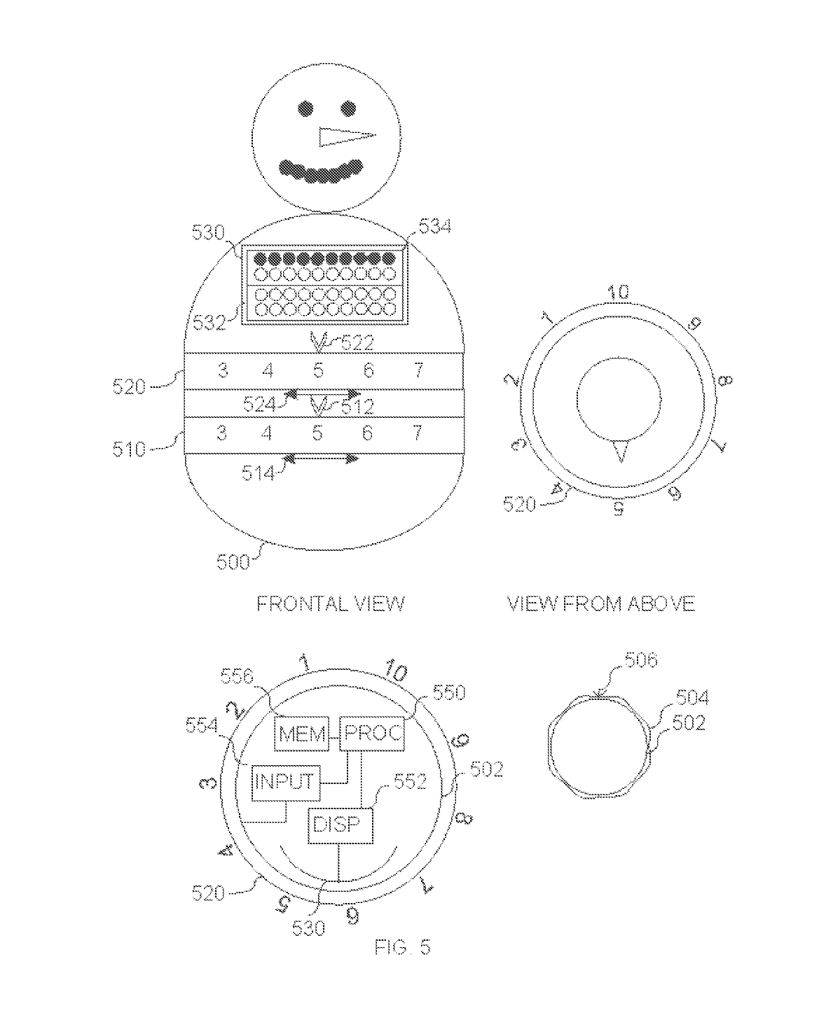

FIG. 4 is a block diagram illustrating an apparatus in one embodiment of the invention. In FIG. 4 there is an apparatus 400, which is, for example, a table computer, a pocket calculator, a mobile node, user equipment, a handset, a cellular phone, a mobile terminal, an Application Specific Integrated Circuit (ASIC), a chip or a chipset. The internal functions of apparatus 400 are illustrated with a box 402. Apparatus 400 comprises at least one processor 410. Connected to the at least one processor 410 there may be a first memory 420, which is, for example, a Random Access Memory (RAM). There may also be a second memory 430, which may be a non-volatile memory, for example, an optical or magnetic disk or a flash memory. There may also be a display 414. There may also be a touch sensitive array 416 of sensors in association with display 414. There may also be a keypad 418, which may comprise navigation keys for navigating a cursor or a focus selector in upward, downward, left and right direction. The keypad may comprise a key for selecting a band or other user interface object pointed to by the cursor or focus selector. In memory 420 there may be stored software relating to functional entities 422-428. An operating system 422 is responsible for controlling display 414, touch sensitive array 416 and keypad 418. The operating system may comprise a library 424 for controlling a graphical user interface displayed on display 414. Library may 424 comprise at least one method 426 for determining user input for moving at least one band on display 414. The user input may be used for determining at least one operand for at least one mathematical operation. A calculator application 428 communicates with operating system 422 and the at least one method 426. The communication may be used to display results of the mathematical operations performed on the operands determined.

When the at least one processor 414 executes functional entities associated with the invention, memory 422 comprises entities such as, any of the functional entities 432 and 434. The functional entities within apparatus 400 illustrated in FIG. 4 may be implemented in a variety of ways. They may be implemented as processes executed under the native operating system of the network node. The entities may be implemented as separate processes or threads or so that a number of different entities are implemented by means of one process or thread. A process or a thread may be the instance of a program block comprising a number of routines, that is, for example, procedures and functions. The functional entities may be implemented as separate computer programs or as a single computer program comprising several routines or functions implementing the entities. The program blocks are stored on at least one computer readable medium such as, for example, a memory circuit, memory card, magnetic or optical disk. Some functional entities may be implemented as program modules linked to another functional entity. The functional entities in FIG. 4 may also be stored in separate memories and executed by separate processors, which communicate, for example, via a message bus or an internal network within the network node. An example of such a message bus is the Peripheral Component Interconnect (PCI) bus.

The embodiments of the invention described hereinbefore in association with the summary of the invention, FIGS. 1, 2, 3 and 4 may be used in any combination with each other. Several of the embodiments may be combined together to form a further embodiment of the invention.

FIG. 5 illustrates an electronic device in one embodiment of the invention. In FIG. 5 the electronic device is illustrated from the front and from the above. The structure of the electronic device is also illustrated.

Electronic device 500 is illustrated in FIG. 5 in the form of a snowman. The visual details may vary from embodiment to embodiment. Electronic device 500 comprises a first rotatable wheel 510 and a second rotatable wheel 520 which are placed around a housing 502 of electronic device 500. On first wheel 510 and on second wheel 520 are printed numbers or other symbols denoting numbers in numerical order. Currently selected number on first wheel 510 is indicated with chevron 512 or other mark on housing 502. Similarly, currently selected number on second wheel 520 is indicated with chevron 522 or other mark on housing 502. Wheels 510 and 520 may be rotated around in steps that keep chevron 512 and chevron 522 always pointing a number on wheels 510 and 520, respectively. Housing 502 may be casted in the form of a cogwheel 504 under wheels 510 and 520. The dents of the cogwheel 504 may be smoothed. Wheels 510 and 520 may have at least one spring 506 attached to their inner annular surfaces (not shown) in order to ensure that the rotating of wheels occurs in steps that keep chevrons 512 and 522 in line with a number printed on the wheels 510 and 520. The at least one spring 506 extends when in contact with a notch of a cogwheel and retracts when in contact with a dent of a cogwheel. Alternatively, the inner annular surfaces of wheels 510 and 520 may be casted to have dents, whereas to the surface of housing 502 may be attached at least one spring to keep chevrons 512 and 522 in line with a number printed on the wheels 510 and 520.

Electronic device 500 also comprises a display 530 which may be a Light Emitting Diode (LED) display or an array of separate LEDs. On a first portion 534 of display 530 is indicated the result of a first mathematical operation on operands selected by the user of electronic device 500 using rotatable wheels 510 and 520. On a second portion 532 of display 530 is indicated the result of a second mathematical operation on operands selected by the user of electronic device 500 using rotatable wheels 510 and 520. The result may be displayed as the number of LEDs lighted on a display portion. Alternatively, the result may be displayed as a number on the display portion, for example, as illustrated in FIGS. 1 and 2 in result area 130.

Electronic device 500 may comprise a processor 550, a wheel position sensor circuit 554 and a display control circuit 552. Processor 550 is configured to determine the current positions of rotatable wheels 510 and 520 using a wheel position sensor circuit 554, to determine a first operand based on the position of wheel 510, to determine a second operand based on the position of wheel 520, to perform a first mathematical operation on the first operand and the second operand in response to the determination of at least one of the first operand and the second operand, to perform a second mathematical operation on the first operand and the second operand in response to the determination of at least one of the first operand and the second operand, to display the result of the first mathematical operation on a first display portion via display control circuit 552 and to display the result of the second mathematical operation on a second display portion via display control circuit 552. Processor 550 may be configured to perform the aforementioned steps using a computer program stored on a computer readable medium 556, for example, stored on a Read-Only Memory (ROM) circuit connected to processor 550. Wheel position sensor circuit 554 may comprise variable resistors for wheels 510 and 520, the resistance of which is varied by moving wheels 510 and 520. The voltages via the variable resistors may be sensed by position sensor circuit 554, digitized and fed for input to processor 550.

The embodiments of the invention described hereinbefore in association with the summary of the invention, FIGS. 1, 2, 3, 4 and 5 may be used in any combination with each other. Several of the embodiments may be combined together to form a further embodiment of the invention.

As used in this application, the term ‘circuitry’ and ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3G communications networks, 4G communications networks Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices, or one or more software entities such as modules.

The exemplary embodiments can store information relating to various processes described herein. This information can be stored in one or more memories, such as a hard disk, optical disk, magneto-optical disk, RAM, and the like. One or more data-bases can store the information regarding cyclic pre-fixes used and the delay spreads measured. The data-bases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of one or more application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

The embodiments of the invention described hereinbefore in association with the figures presented and the summary of the invention may be used in any combination with each other. Several of the embodiments may be combined together to form a further embodiment of the invention.

It is obvious to a person skilled in the art that with the advancement of technology, the basic idea of the invention may be implemented in various ways. The invention and its embodiments are thus not limited to the examples described above; instead they may vary within the scope of the claims.

1. A method, comprising:
determining a first user input for scrolling a first band on a display of a device, the first band comprising a first line of numbers in a numerical order, the display having a first position corresponding to a currently selected number on the first band;
determining in the device a first operand from the first user input, the first operand being the currently selected number on the first band;
determining a second user input for scrolling a second band on the display, the second band comprising a second line of numbers in a numerical order, the display having a second position corresponding to a currently selected number on the second band;
determining in the device a second operand from the second user input, the second operand being the currently selected number on the second band; and
displaying on the display results of at least two mathematical operations involving the first operand and the second operand, in a direct response to determining at least one of the first operand and the second operand.

2. The method according to claim 1, wherein the step of determining the first user input further comprises determining a user input which corresponds to a touch gesture for scrolling on a touch sensor array associated with the display.

3. The method according to claim 1, wherein the step of determining the first user input further comprises determining a user input which corresponds to a selection of the first band using a navigation keypad of the device and a pressing of a direction key on the navigation keypad.

4. The method according to claim 1, the method further comprising:
determining a third user input for scrolling the first band or the second band in a direction perpendicular to the line of numbers on the first band or the second band; and
displaying an updated line of numbers in an increasing order on the first band or the second band with increased precision of at least one further decimal place.

5. The method according to claim 1, the method further comprising:
determining a fourth user input for scrolling a result area on the display for displaying the results; and
changing at least one of the at least two mathematical operations to a further mathematical operation in response to the fourth user input.

6. The method according to claim 5, the method further comprising:
displaying a third band on the display in response to the fourth user input, the third band having a default position corresponding to a currently selected default number on the third band.

7. The method according to claim 1, wherein the first band and the second band are horizontal bands.

8. The method according to claim 1, wherein the numbers and the results are displayed with number symbols that show a number of entities, the number of entities corresponding to the number being displayed.

9. The method according to claim 1, wherein the first mathematical operation comprises one of addition, subtraction, multiplication and division.

10. An apparatus, comprising:
a memory;
a display; and
at least one processor configured to determine a first user input for scrolling a first band on a display, the first band comprising a first line of numbers in numerical order, the display having a first position corresponding to a currently selected number on the first band, to determine a first operand from the first user input, the first operand being the currently selected number on the first band, to determine a second user input for scrolling a second band on a display, the second band comprising a second line of numbers in numerical order, the display having a second position corresponding to a currently selected number on the second band, to determine a second operand from the second user input, the second operand being the currently selected number on the second band, and to display on the display results of at least two mathematical operations involving the first operand and the second operand, in a direct response to determining at least one of the first operand and the second operand.

11. A computer program stored on a computer readable medium comprising code adapted to cause the following when executed on a data-processing system:
determining a first user input for scrolling a first band on a display, the first band comprising a first line of numbers in a numerical order, the display having a first position corresponding to a currently selected number on the first band;
determining a first operand from the first user input, the first operand being the currently selected number on the first band;
determining a second user input for scrolling a second band on a display, the second band comprising a second line of numbers in a numerical order, the display having a second position corresponding to a currently selected number on the second band;
determining a second operand from the second user input, the second operand being the currently selected number on the second band; and
displaying on the display results of at least two mathematical operations involving the first operand and the second operand, in a direct response to determining at least one of the first operand and the second operand.

12. An apparatus, comprising:
a substantially circular housing;
a first rotatable wheel around the housing;
a second rotatable wheel around the housing;
a wheel position sensor circuit for sensing the position of the first wheel and the second wheel;
a display;
a processor configured to determine a current position of the first rotatable wheel via the wheel position sensor circuit, to determine a first operand based on the current position of the first wheel, to determine a current position of the second rotatable wheel via the wheel position sensor circuit, to determine a second operand based on the current position of the second wheel, to perform a first mathematical operation on the first operand and the second operand in response to the determination of at least one of the first operand and the second operand, to perform a second mathematical operation on the first operand and the second operand in response to the determination of at least one of the first operand and the second operand, to display the result of the first mathematical operation on a first display portion on the display, and to display the result of the second mathematical operation on a second display portion on the display.
